(19) United States
(12) Patent Application Publication
(10) Pub. No.: US 2018/0007947 A1
(43) Pub. Date: Jan. 11, 2018

(54) Watermelon Slicer

(71) Applicant: Glen Preston Hunt, Corvallis, OR (US)

(72) Inventor: Glen Preston Hunt, Corvallis, OR (US)

(21) Appl. No.: 15/203,067

(22) Filed: Jul. 6, 2016

(51) Int. Cl. A23N 7/02; B26D 3/26

(52) U.S. Cl. CPC A23N 7/023; B26D 3/26; B26D 2210/02

(57) ABSTRACT

A watermelon slicer/de-rinder capable of storing the unused portion of watermelon is provided herein. Embodiments of the present invention comprise two main components, a base to which a watermelon is to be secured, and a slicing mechanism which cuts the watermelon. When enough slices of watermelon are removed, the slicing mechanism is placed back on the watermelon and the knife handles are pushed back in. The invention is attached to the watermelon and they are now ready for storing for future eating. The base of the watermelon slicer/de-rinder is used to secure the remaining watermelon and prevent it from falling.

This application claims priority to U.S. Provisional Patent Application Ser. No. 62/231,430 filed on Jul. 6, 2016 entitled “Rotating Spinner Blade Assembly for Fishing Lures”, the disclosure of which is hereby incorporated by reference.

### BACKGROUND OF THE INVENTION

The invention pertains to the field of food slicers. More particularly, the invention pertains to a watermelon slicer.

### 2. Description of Related Art

Slicers of vegetables and fruit have been used in the past to ease the removal of the edible portion of the vegetable or fruit for consumption by a user. For example, U.S. Pat. No. 4,546,545, entitled, “Pineapple Cutter” by Hirano discloses a pineapple cutter with a cylindrical body having a cutting edge at the surface end of the lower portion, a pair of handles connected to the outer surface of the cylindrical body, a pressing sheet mounted on the inner portion of the cylindrical body slideable in the vertical direction and a pushing member secured to the upper portion of the cylindrical body connected with the pressing sheet. A second pressing sheet with a smaller diameter than the pressing sheet is located within the pressing sheet to core the pineapple. When used to cut the pineapple, the rind is removed at the same time the core of the pineapple is removed. The exposed cutting edges of U.S. Pat. No. 4,546,545 cause user safety risk. U.S. Pat. No. 4,546,545 could even be seen as an ejector assembly to deal with the obvious difficulty of removing pineapple from the cutter device of Hirano's U.S. Pat. No. 4,490,912.

U.S. Pat. No. 1,744,422, entitled “Fruit and Vegetable Cutter” by Taylor discloses a handle with detachable cutting head. The detachable cutting head is attached to the handle and a funnel type cylindrical portion with through threads. This cutter dices the entire vegetable or fruit including the outside skin. This cutter could not be used for a watermelon for example, because to push the cutter inside of the watermelon flesh, the screw thread connection would be too thick and additionally the holder around the funnel portion of the cutter would also not be able to be pushed through the watermelon flesh. Furthermore, the cutter can only accommodate items which fit entirely within the cutting circle.

U.S. Pat. No. 4,490,912, entitled “Pineapple Cutter” by Hirano discloses a pineapple cutter with handles attached to a cylinder which has a cutter portion. The cylinder of the pineapple cutter is adapted to punch the outer peel and the interior of the pineapple to separate the peel from the interior of the pineapple. The pineapple cutter cuts into the outer peel of the pineapple in order to separate it from the interior of the pineapple. Furthermore, based on the design and the need to “punch” the pineapple cutter through the pineapple in order to slice it, softer flesh, such as the interior of a watermelon would be significantly damaged in the process of removing the flesh from the cutter assembly as described in this patent.

Therefore, there is a need for a watermelon slicer that can remove the rind of the watermelon without damaging the fleshy interior.

### BRIEF SUMMARY OF THE INVENTION

The present invention provides a watermelon slicer/de-rinder capable of storing the unused portion of watermelon. Embodiments of the present invention comprise two main components, a base to which a watermelon is to be secured, and a slicing mechanism which cuts the watermelon. When enough slices of watermelon are removed, the slicing mechanism is placed back on the watermelon and the knife handles are pushed back in. The invention is attached to the watermelon and they are now ready for storing for future eating. The base of the watermelon slicer/de-rinder is used to secure the remaining watermelon and prevent it from falling.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

### BRIEF DESCRIPTION OF THE FIGURES

FIG. 1 is a perspective view of a watermelon slicer as according to an embodiment of the present invention;

FIG. 2 is a side view of a watermelon slicer as according to an embodiment of the present invention; and

FIG. 3 is a top view of a watermelon slicer as according to an embodiment of the present invention.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method(s) or apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

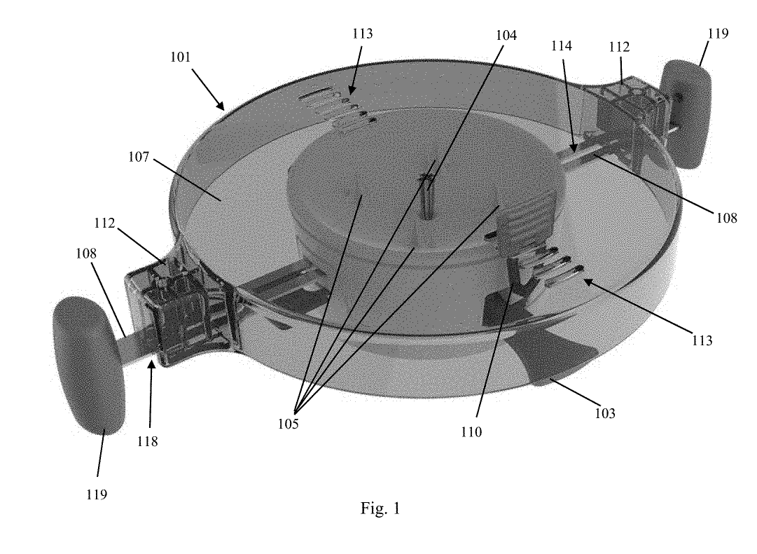

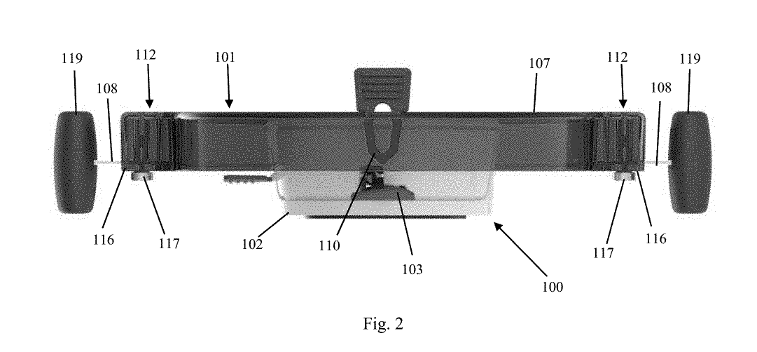

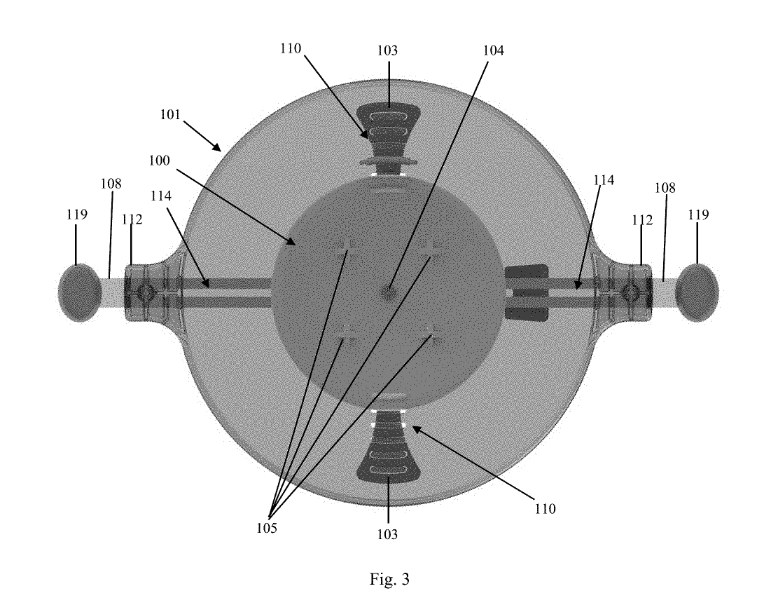

Now referring to FIGS. 1-3, that will be discussed together, there are shown views of a watermelon slicer as according to embodiments of the present invention.

The watermelon slicer consists of two main components, the base (100) which the watermelon is to be secured in a vertical position and the slicing mechanism (101) which cuts the watermelon slices in succession, approximately 1¼″ from the top down.

The base (100) consists of three main parts: the body (102) of the base (100) of which all other parts of the base (100) are contained, the handles (103) and the suction cup. The body (102) is a vertical cylinder which has an inverted bowl shape (reflecting the mirror image of the end of a watermelon) for a top. This bowl shape has four spikes (105) positioned equal distance apart in the inverted bowl shape of the body (102) for stabilizing the watermelon when it is placed on top for slicing. In addition to this are the two handles (103) that come out of the body (102) on opposite sides of the cylinder of the body (102). These handles (103) can be pushed down to create a fulcrum effect lifting up upon plunger (106) that is connected to the suction cup.

The engagement of the suction cup stabilizes the base (100) to a clean dry smooth surface. In securing of the base (100) to the watermelon with the spikes (105) and securing the base (100) to a typical countertop by engaging the suction cup the watermelon is ready to slice. All parts can be made from materials such as acrylic (with exception to the suction cup), but are not limited to acrylic. The parts can also be made of any food grade metal or any other form of plastic.

The slicing mechanism (101) further comprises three parts, the top (107) of which all other parts are contained, the slicing knives (108) that are encased in a chamber (112) at opposing sides of the top (107), and the de-rinding knives (110) that can be placed in the top (107) in opposing sides to separating the watermelon meat from the rind. The slicing mechanism (101) is flat and in a circular shape and has a spike (104) on the underneath center to center the slicing mechanism (101) on the watermelon.

In addition to being flat, there are two chambers (112) on opposing sides of the top (107) to encase the slicing knives (108). These chambers (112) have horizontal slots (118) in the sides about 1¼″ in from the top (107) giving you the typical watermelon slice. The slicing knives (108) are flat and can be made of food grade stainless steel, but are not limited to that. They also have slots (114) going down the center of the blade lengthwise. These slots (114) fit into notches (115) in the chamber (112) of the top (107) to keep the blades straight, level and horizontal to the top (107). The knives (108) have handles (119) perpendicular to the blade to push in to penetrate the watermelon and then to be pulled out to release the slice after it has been cut. The slots in the knives (108) also prevent the knives (108) from coming all the way out and stop when all the way in the watermelon.

The chamber (112) has a bottom plate (116) that is held in place with a screw (117) for removal and cleaning of the knives (108), (110). This bottom plate (116) has a notch in the top side to fit into the knife slot (114) for stability. The bottom plate (116) is made of UHMW but not limited to that. There are adjacent slots (113) in the top of the slicing mechanism (101) for de-rinding knives (110). These knives (110) are put in at opposing sides in corresponding locations to separate the watermelon meat from the rind. They work in accord with the slicing knives (108) and can be made of acrylic, but not limited to being made of acrylic.

To cut a watermelon into slices and de-rind it in one motion, place the base (100) on a clean dry and smooth surface with suction cup side down. Place one hand on each handle (103) of opposing sides of the base (100), press down and counter clockwise to engage the suction cup to secure the base (100) to a flat surface. Check to make sure the base (100) has adhered to the surface with an attempt to twist of the base (100). Then a watermelon is placed on the stationary base (100) with the long-axis of the watermelon relatively vertical. Push down on the watermelon to pierce the rind of the watermelon with the spikes (105) on the base (100) to secure the watermelon to the base (100).

Next, pull out the handles (119) on opposing sides of the slicing mechanism (101) and center over the watermelon. Exert downward force on the center of the slicing mechanism (101) to pierce the spike (105) into the top of the watermelon. Push in the opposing handles (119) all the way in to penetrate the watermelon. With one handle (119) in each hand, rotate the top (107) ½ turn clockwise or counter clockwise to slice off the top of the watermelon, discard top piece. Place the slicing mechanism (101) back on the watermelon centering spike (105) with previous spot left by spike (105). Push in the opposing knife handles (119) and give ½ turn to cut first slice. Lift off and pull out knife handles (119) over a to release watermelon slice. Place back on watermelon centering with previous mark left by spike (105) and push in knife handles (119) and repeat for additional number of slices.

If it is desired that the watermelon meat be separated from the rind take out the de-rinding knives (110) stored in the slot on the base (100). Place knives (110) in corresponding slots (113) in the top (107) of the slicing mechanism (101) in opposing sides. As in above instructions give the watermelon slicer ½ turn and pull out the knife handles (119) over a serving plate to release watermelon meat and separated rind on the serving plate.

In addition to being a watermelon slicer/de-rinder, this invention also stores the unused portion of watermelon. When desired slices of watermelon are removed from watermelon place slicing mechanism (101) back on watermelon and push in knife handles (119). Now it is ready for storing the watermelon on the base (100) with top attached in your refrigerator for future eating. Using the base (100) to secure the remaining watermelon and the top of the watermelon to preserve freshness.

There are described and illustrated new and improved watermelon slicer, and methods for formulating the watermelon slicer. The inventive portions of the watermelon slicer include several components and steps that, when taken together, constitute an embodiment of the present invention. The above detailed description sets forth rather broadly the more important features osf the present invention in order that its contributions to the art may be better appreciated.

As such, those skilled in the art will appreciate that the conception, upon which disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, apparatus, apparatus and articles of manufacture have been described herein, the scope of coverage of this application is not limited thereto. On the contrary, this application covers all methods, apparatus and articles of manufacture fairly falling within the scope of the invention either literally or under the doctrine of equivalents.

Directional terms such as “front”, “forward”, “back”, “rear”, “in”, “out”, “downward”, “upper”, “lower”, “top”, “bottom”, “upper”, “lower” and the like may have been used in the description. These terms are applicable to the embodiments shown and described herein. These terms are merely used for the purpose of description and do not necessarily apply to the position in which components or items within the present invention may be used.

Therefore, the foregoing is considered as illustrative only of the principles of a watermelon slicer. Further, since numerous modifications and changes will readily occur to those skilled in the art, it is not desired to limit the watermelon slicer to the exact construction and operation described, and accordingly, all suitable modifications and equivalents may be resorted to, falling within the scope of the present invention. While the above description describes various embodiments of the present invention, it will be clear that the present invention may be otherwise easily adapted to fit other configurations.

As various changes could be made in the above constructions without departing from the scope of the invention, it is intended that all matter contained in the above description shall be interpreted as illustrative and not in a limiting sense.

What is claimed is:

1. An apparatus comprising:
two or more slicing knives, one or more de-rinding knives, and a top; the slicing knives, de-rinding knives and the top forming a slicing mechanism of the apparatus;
two or more handles, a suction cup, and a body that form the base of the apparatus;
wherein the slicing mechanism further comprises a spike that is shaped to pierce an end of a watermelon, the slicing mechanism rotating in a circular motion around the spike when the spike is inserted into the watermelon;
and wherein the base further comprises at least two spikes that are shaped to penetrate the opposite end of the watermelon than the spike of the slicing mechanism and are shaped to prevent the watermelon from rotating when the slicing mechanism is rotated.

2. The apparatus of claim 1 wherein the slicing knives of the slicing mechanism are located on opposite sides of the slicing mechanism from each other.

3. The apparatus of claim 1 wherein there are two de-rinding knives.

4. The apparatus of claim 1 wherein the de-rinding knives are placed into one of a plurality of slots on the top of the slicing mechanism.

5. The apparatus of claim 1 wherein the slicing knives can be slid in and out from the slicing mechanism.

6. The apparatus of claim 1 wherein the suction cup of the base is attached to a plunger, the plunger being attached to the body of the base.

7. The apparatus of claim 6 wherein the suction cup is shaped so that it secures the base of the apparatus to a flat surface after being pressed down on the flat surface.

8. An apparatus for slicing watermelons comprising:
a base, the base further comprising a body, handles, and a suction cup;
a slicing mechanism, the slicing mechanism further comprising a top, at least two slicing knives, and at least one de-rinding knives;
the body of the base being a vertical cylinder terminating in an upward-facing inverted bowl that roughly approximates the shape of an end of a watermelon, the bowl having a plurality of spikes that are designed to penetrate a watermelon placed on the base; the handles of the base being located on opposite sides of the base and extendable from the cylinder portion of the body of the base, the handles being attached to the body so that when pushed down a fulcrum effect is created that lifts a plunger that is connected to the suction cup of the base, the suction cup of the base being located on the bottom of the base and attached to the plunger that is attached to the body of the base, the suction cup being designed so that when placed on a flat surface and pressed downward, the suction cup secures the base to the flat surface; and
the top of the slicing mechanism containing the slicing knives and the de-rinding knife, the slicing knives being encased in a chamber in the top and oriented on opposite sides of the top from each other, the top of the slicing mechanism further comprising a spike that is designed to penetrate an end of a watermelon when the slicing mechanism is placed on the watermelon.

9. The apparatus for slicing watermelons of claim 8 wherein the slicing knives are slideably mounted to the slicing mechanism so that they can be slid in and out from the slicing mechanism.

10. The apparatus for slicing watermelons of claim 9 wherein the blades of the slicing knives are roughly perpendicular to the blades of the de-rinding knives.

11. The apparatus for slicing watermelons of claim 8 wherein the de-rinding knives are placed in one of a plurality of slots in the top of the slicing mechanism.

12. The apparatus for slicing watermelons of claim 11 wherein the slots in the top of the slicing mechanism are placed in a line extending outward from the center of the top of the slicing mechanism.

13. The apparatus for slicing watermelons of claim 8 wherein the spike in the slicing mechanism is positioned in the center of the slicing mechanism so that the slicing mechanism can be rotated clockwise or counter-clockwise around the long-axis of a watermelon.

14. The apparatus for slicing watermelons of claim 8 wherein the slicing mechanism and base are shaped to fit together when at least a portion of a watermelon is left on the base.

15. A watermelon slicing and storing apparatus comprising:
a base that stabilizes a watermelon, the base having: one or more spikes that penetrate a watermelon when the watermelon is pressed onto the base, the spikes being shaped to prevent the watermelon from moving during slicing of the watermelon; a suction cup that attaches the base to a flat surface when the suction cup is pressed onto the surface; two handles that allow a user to press the suction cup firmly onto the flat surface;
a slicing mechanism that separates a portion of the watermelon from the remainder of the watermelon when the slicing mechanism is rotated ½ turn or less, the slicing mechanism having: at least two slicing knives that slice the watermelon when the slicing mechanism is rotated; a de-rinding knife located at the top of the slicing mechanism that de-rinds the watermelon when the slicing mechanism is rotated, the de-rinding knife being adjustably distanced from the center of the slicing mechanism by placing the de-rinding knife in one of a plurality of slots located in the top of the slicing mechanism; and
the base and slicing mechanism being shaped so that they fit together to store a portion of a watermelon within the interior of the apparatus when the apparatus is not being used to slice the watermelon.

16. The watermelon slicing and storing apparatus of claim 15 wherein the suction cup is attached to a plunger that extends downward from the base when a user presses on the handles.

17. The watermelon slicing and storing apparatus of claim 15 wherein two slicing knives are located on opposite sides of the slicing mechanism from each other.

18. The watermelon slicing and storing apparatus of claim 17 wherein the blades of the two slicing knives are in the same plane as each other.

19. The watermelon slicing and storing apparatus of claim 15 wherein the slicing knives are extendably attached to the slicing mechanism.
The watermelon slicing and storing apparatus of claim 19 further comprising a chamber in which at least one slicing knife is housed.
